(19) United States
(12) Patent Application Publication
(10) Pub. No.: US 2023/0093933 A1
(43) Pub. Date: Mar. 30, 2023

(54) LOW LATENCY AUGMENTED REALITY ARCHITECTURE FOR CAMERA ENABLED DEVICES

(71) Applicant: Advanced Micro Devices, Inc., Santa Clara, CA (US)

(72) Inventors: Hui Zhou, Shanghai (CN); Guhan Krishnan, Boxborough, MA (US); Dong ZhongFei, Shanghai (CN)

(73) Assignee: Advanced Micro Devices, Inc., Santa Clara, CA (US)

(21) Appl. No.: 17/500,790

(22) Filed: Oct. 13, 2021

(30) Foreign Application Priority Data
Sep. 27, 2021 (CN) 202111134551.3

(51) Int. Cl. H04N 5/232; G06F 13/28; G06F 9/54

(52) U.S. Cl. CPC H04N 5/23206; G06F 13/28; G06F 9/546; G06F 9/544; G06T 19/006

(57) ABSTRACT

Systems and methods are disclosed that provide low latency augmented reality architecture for camera enabled devices. Systems and methods of communication between system components are presented that use a hybrid communication protocol. Techniques include communications between system components that involve one-way transactions. A hardware message controller is disclosed that controls out-buffers and in-buffers to facilitate the hybrid communication protocol.

### CROSS REFERENCE TO RELATED APPLICATION

This application claims priority to Chinese Patent Application No. 202111134551.3, filed Sep. 27, 2021, the entire contents of which is hereby incorporated by reference as if fully set forth herein.

### BACKGROUND

Systems that process live video in a pipelined manner are latency-sensitive systems. The end-to-end processing time of a pipelined data element (e.g., a video frame), that is the systems' latency, should be kept low in order to maintain high quality of user experience. Low latency is a challenging requirement given the amount of data that such systems have to process. This is especially so for systems that process the live feeds of multiple cameras and given the high demand for content at a high resolution and at a high dynamic range. Typically, such systems process a video feed sequentially across a pipeline, with an overall processing time that is limited by the video frames' resolution, dynamic range, and rate. For example, Augmented Reality (AR) systems that support AR-based applications, in addition to handling in real-time multiple video streams, have to employ computer vision and image processing algorithms of high complexity. For such AR systems, low latency is imperative; otherwise, the user's immersive experience will be compromised.

### BRIEF DESCRIPTION OF THE DRAWINGS

A more detailed understanding can be achieved through the following description given by way of example in conjunction with the accompanying drawings wherein:

FIG. 1 is a block diagram of an example device in which one or more features of the disclosure can be implemented;

FIG. 2 is a block diagram of an example AR system, employable by the device of FIG. 1, in which one or more features of the disclosure can be implemented;

FIG. 3 is a functional block diagram of an example AR system and an example camera enabled device, in which one or more features of the disclosure can be implemented;

FIG. 4 is a diagram that demonstrates latency, introduced by the camera enabled device and the AR system of FIG. 3, for frame-based processing;

FIG. 5 is a diagram that demonstrates latency, introduced by the camera enabled device and the AR system of FIG. 3, for slice-based processing;

FIG. 6 is a block diagram of an example software-based communication protocol, in which one or more features of the disclosure can be implemented;

FIG. 7 is a block diagram of an example hybrid communication protocol, in which one or more features of the disclosure can be implemented; and

FIG. 8 is a flow chart of a method, with which one or more features of the disclosure can be processed.

### DETAILED DESCRIPTION

The present disclosure describes systems and methods for reducing the latency of a real-time system that processes live data in a pipelined manner. For purposes of illustration only, features disclosed in the present disclosure are described with respect to an AR system and a camera enabled device. However, features disclosed herein are not so limited. The methods and systems described below are applicable to other latency-sensitive systems, such as systems related to Human Computer Interface (HCI) or Autonomous Vehicles (AV) that run on any computing device, such as a laptop, a tablet, or any other wearable devices.

An AR system and a camera enabled device are described to demonstrate the benefit of the low latency systems and methods disclosed herein. Camera enabled devices—such as Head Mounted Devices (HMDs) or handheld mobile devices—interface with AR systems to provide users with immersive experience when interacting with device applications in gaming, aviation, and medicine, for example. Such immersive applications, typically, capture video data that cover a scene currently being viewed by the user and insert (or inlay), via an AR system, content (e.g., an enhancement such as a virtual object) into the video viewed by the user or onto an image plane of a see-through display. To facilitate the immersive experience, the content has to be inserted in a perspective that matches the perspective of the camera or the perspective in which the user views the scene via the see-through display. As the camera moves with the user's head movements (when attached to an HMD) or with the user's hand movements (when attached to a mobile device), the time between the capturing of a video and the insertion of an enhancement must be very short. Otherwise, the immersive experience will be compromised as the enhancement will be inserted at a displaced location and perspective. In other words, the latency of the AR system should be low.

AR systems employ complex algorithms that process video data and metadata. These algorithms, for example, include computing a camera-model of the camera (or the camera's pose), a three-dimensional (3D) reconstruction of the scene captured by the camera (i.e., a real-world representation of the scene), detection and tracking of the user's gaze and objects located at the scene, and mapping of a virtual (animated) object that is placed at the real-world representation of the scene onto a projection plane (either the camera's image plane or an image plane consistent with the user's gaze). For example, an AR system, can process a video of a table in a room, as captured by a user's HMD's camera. Through the operations described above the AR system can insert into the video a virtual object placed in perspective on the top of the table. As the user (and the attached camera) moves, the AR system can continuously compute the camera-model, track the table, and update the perspective in which the virtual object is inserted into the video. As long as the AR system's operation is with sufficiently low latency, the update of the virtual object insertion will be frequent enough to allow an immersive experience as the user (and therefore the camera) moves.

The present disclosure describes a method of communication between system components, using a hybrid communication protocol. The hybrid communication protocol comprises the operations of processing a slice of a video by a first system component; sending a first message to a second system component, indicating that the processed slice is stored in a memory, wherein the sending of the first message comprises writing the first message, stored in an out-buffer of the first system component, into a mailbox of the second system component; and receiving a hardware interrupt issued by the second system component, indicating that the mailbox is released. In an alternative, the out-buffer is managed by a hardware message controller that controls the writing, by the first system component, of messages to the out-buffer via a direct memory access. The method further comprises receiving a second message from the second system component, indicating that a further processing of the processed slice is completed and that the further processed slice is stored in the memory, wherein the receiving of the second message is a one-way transaction that comprises reading the message from an in-buffer of the first system component and wherein the reading completes the transaction. In an alternative, the in-buffer is managed by the hardware message controller that controls the reading, by the first system component, of messages from the in-buffer via a direct memory access.

The present disclosure further discloses a first system component that comprises at least one processor and memory storing instructions. The instructions, when executed by the at least one processor, cause the first system component to: process a slice of a video; send a first message to a second system component [CVIP], indicating that the processed slice is stored in a memory, wherein the sending of the first message comprises writing the first message, stored in an out-buffer of the first system component, into a mailbox of the second system component; and receive a hardware interrupt issued by the second system component, indicating that the mailbox is released. In an alternative, the out-buffer is managed by a hardware message controller that controls the writing, by the first system component, of messages to the out-buffer via a direct memory access. The instructions further cause the first system component ton receive a second message from the second system component, indicating that a further processing of the processed slice is completed and that the further processed slice is stored in the memory, wherein the receiving of the second message is a one-way transaction that comprises reading the message from an in-buffer of the first system component and wherein the reading completes the transaction. In an alternative, the in-buffer is managed by the hardware message controller that controls the reading, by the first system component, of messages from the in-buffer via a direct memory access.

Furthermore, the present disclosure further discloses a non-transitory computer-readable medium comprising instructions executable by at least one processor to perform a method. The method comprises: processing a slice of a video by a first system component; sending a first message to a second system component, indicating that the processed slice is stored in a memory, wherein the sending of the first message comprises writing the first message, stored in an out-buffer of the first system component, into a mailbox of the second system component; and receiving a hardware interrupt issued by the second system component, indicating that the mailbox is released. The method further comprises receiving a second message from the second system component, indicating that a further processing of the processed slice is completed and that the further processed slice is stored in the memory, wherein the receiving of the second message is a one-way transaction that comprises reading the message from an in-buffer of the first system component and wherein the reading completes the transaction.

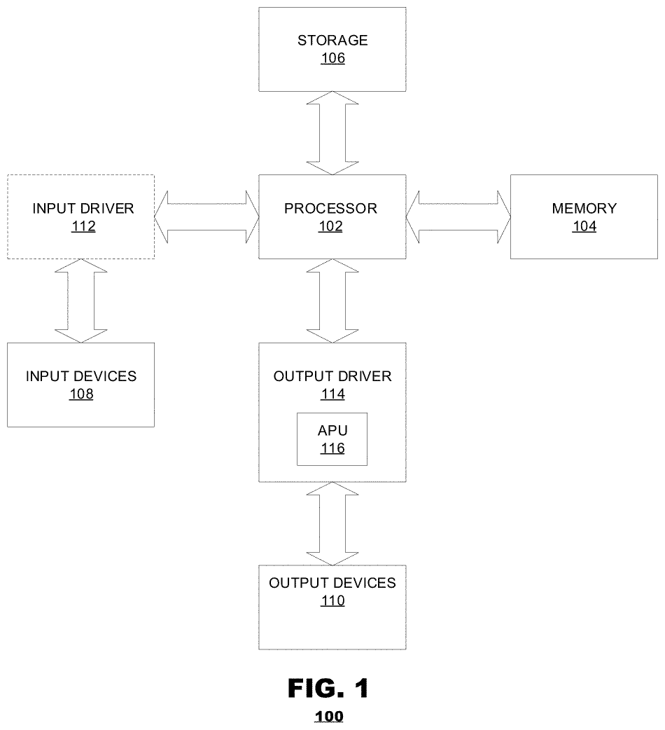

FIG. 1 is a block diagram of an example device 100 in which one or more features of the disclosure can be implemented. The device 100 can include, for example, a computer, a gaming device, a handheld device, a set-top box, a television, a mobile phone, a server, a tablet computer, or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102 or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing unit (“APU”) 116 which is coupled to a display device 118. The APU accepts compute commands and graphics rendering commands from processor 102, processes those compute and graphics rendering commands, and provides pixel output to display device 118 for display. The APU 116 can include one or more parallel processing units to perform computations in accordance with a single-instruction-multiple-data (“SIMD”) paradigm. Thus, although various functionality is described herein as being performed by or in conjunction with the APU 116, in various alternatives, the functionality described as being performed by the APU 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm can perform the functionality described herein. Alternatively, it is contemplated that computing systems that do not perform processing tasks in accordance with a SIMD paradigm can also perform the functionality described herein.

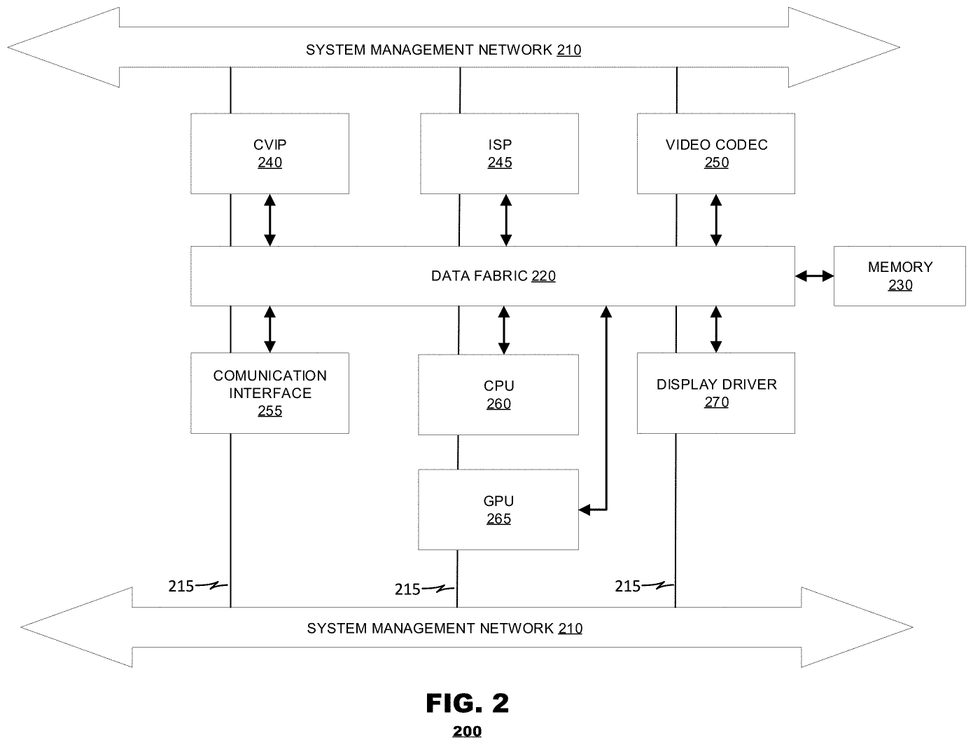

FIG. 2 is a block diagram of an example AR system 200, employable by the device of FIG. 1, in which one or more features of the disclosure can be implemented. The system 200 can include system components such as a Computer Vision Image Processor (CVIP) 240, an Image Signal Processor (ISP) 245, a Video CODEC 250, a communication interface 255, a CPU 260, a GPU 265, a display driver 270, and a memory 230, as well as two buses 210, 220 through which the system's components communicate. The system management network (SMN) 210 is a control bus that facilitates the transfer of messages among the system components 215. For example, the SMN can use a standard AXI-32-based protocol and can include routers and arbitrators to schedule and to manage the messaging among the system's components. The data fabric 220 is a data bus that facilitates the transfer of data from/to a system component to/from the memory 230 (e.g., external DRAMS). In an alternative, the system 200 is a top-level representation of a MERO SoC architecture (based on AMD APU technology), used in connection with camera enabled devices. For example, such an architecture can accommodate two operating systems: a primary operating system, running on the CPU 260 (e.g., processor such as x86 CCX), that governs rendering 265, displaying 270, and driving the image signal processing 245 operations; and a secondary operating system, running on the CVIP 240 (e.g., co-processor such as ARM A55 core cluster) that governs computer vision services provided to the camera enabled device and that device control. For example, an end-user can interface with the primary operating system, using AR-based applications that can utilize data produced by the CVIP's processes, controlled by the secondary operating system.

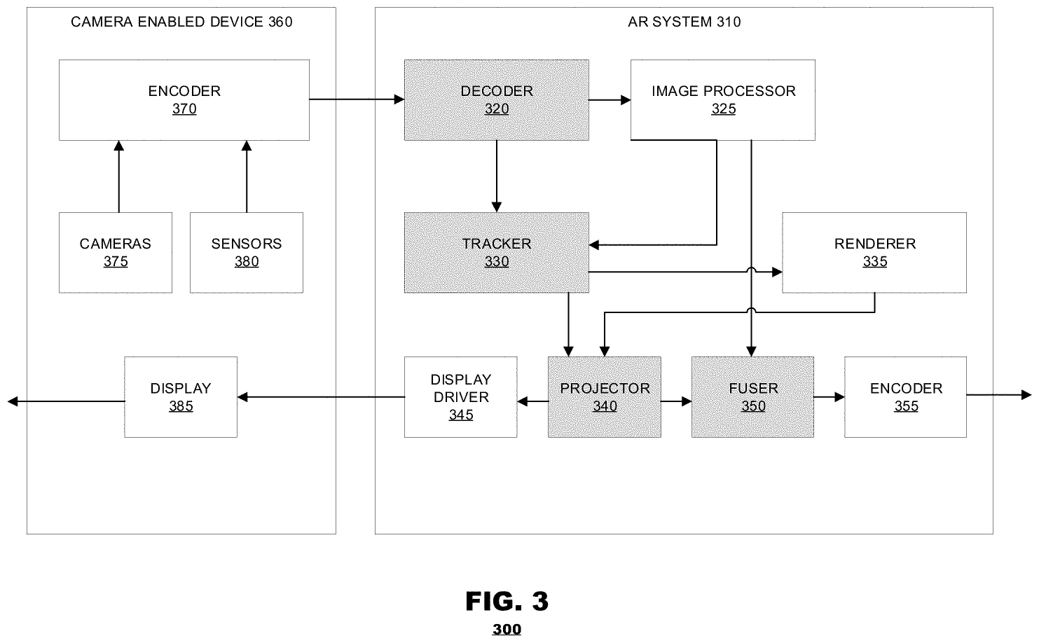

The communication interface 255 (e.g., PCIe) can facilitate video data and control data communication with a camera enabled device. The video CODEC 250 (e.g., AMD VCN) can encode processed video that is streamed back to the camera enabled device, to storage, or out to other destinations. The video CODEC 250 can also decode video received from the camera enabled device or other sources. Alternatively, the video received from the camera enabled device can be decoded by the CVIP 240, as described below with reference to FIG. 3. The display driver 270 (e.g., AMD DCN) is used to drive a display device, such as that presented to a user of the camera enabled device. In an alternative, the CVIP 240 and the ISP 245 perform most of the processing carried out by the AR system 200 when providing computer vision services to the camera enabled device, and, therefore, efforts to reduce the processing latency, and, thereby, improve the immersive experience of the user, are to be focused at these components, as explained below in detail.

In an alternative, the CVIP 240 is a SoC, designed to employ computer vision algorithms to support AR-based applications that run on a camera enabled device. The CVIP 240 can contain a co-processor (e.g., ARM A55 core cluster) and Digital Signal Processors (DSPs), that can interconnect via an internal bus. For example, one DSP can be used to perform machine learning (e.g., Convolutional Neural Network (CNN)) algorithms and another DSP can be used to perform other algorithms of pattern recognition and tracking. The CVIP 240 can run the secondary operating system concurrently with the primary operating system that runs on the CPU 260. For example, a multi-core Linux based OS can be used. The secondary operating system can contain various CVIP software drivers that manage, e.g., memory, DSP control, DMA engine control, clock and power control, IPC messages, secure PCIe handling, system cache control, general fusion controller hubs (FCH) support, watchdog timer, and CoreSight debugging/tracing handling.

The ISP 245 processes decoded video data and corresponding metadata captured by the camera enabled device. In an alternative, the captured video data and corresponding metadata are received by the CVIP 240, via the communication interface 255 (e.g., PCIe), decoded by the CVIP, and then provided to the ISP 245 for processing. Based on the processing of the decoded video and/or corresponding metadata, the ISP can determine camera controls, such as lens exposure, white balancing, and focus, and send these controls to the CVIP to be relayed to the camera enabled device. For example, the ISP can determine parameters of white balancing based on comparison of the video frames' color-histograms or determine parameters of lens exposure or focus based on blur detection applied to the video frames. ISP software can provide an abstraction of a camera sub-system into the primary operating system, thereby bridging the command/data path between applications running on the primary operating system and the ISP. ISP Software in its user space can be responsible to implement the OS required framework APIs to collect configurations of streams and pipelines and to arbitrate the capture requests to an ISP driver in its kernel space. An ISP's kernel driver can manage the power and clocks of the ISP through, e.g., standard graphics service interface. The ISP's kernel driver can also transfer the capture requests and collect the results from the ISP's firmware through ring buffer communication. Off-chip camera devices can also be controlled by the ISP's kernel driver for streaming in desired resolution and frame rate, as inputs to the ISP pipeline.

FIG. 3 is a functional block diagram 300 of an example AR system 310 and an example camera enabled device 360, in which one or more features of the disclosure can be implemented. In an alternative, the camera enabled device includes an encoder 370, one or more cameras 375, one or more sensors 380, and a display 385; the AR system 310 includes a decoder 320, an image processor 325, a tracker 330, a renderer 335, a projector 340, a display driver 345, a fuser 350, and an encoder 355. Functional blocks that perform typical computer vision algorithms can be carried out by the CVIP 240 component of FIG. 2, such as the decoder 320, the tracker 330, the projector 340, and the fuser 350 (see shaded blocks in FIG. 3). The image processor 325 functionality can be carried out by the ISP 245 component of FIG. 2. The functionality of the renderer 335, the encoder 355, and the display driver 345 can be carried out by the GPU 265, the Video CODEC 250, and the display driver 270 of FIG. 2, respectively.

The camera enabled device 360, can represent a mobile device or an HMD. Both can be applied to provide an immersive experience based on augmented reality presentation to a user of the device. For example, when the camera enabled device 360 is an HMD, such a device can include one or more (vision and/or infrared) cameras attached to the device. Some cameras 375 can be facing toward the scene viewed by the user, while some cameras 375 can be facing toward the user's eyes. The former are instrumental for scene recognition and tracking, the latter are instrumental for tracking the user's gaze. Further, an HMD can include a head mounted display 385, such as a see-through display. Employing the processes provided by the AR system 310, the user will be able to see through the display 385 a virtual object placed at the scene at a perspective that matches the user's viewing perspective. In addition, to the video data captured by the cameras 375, the camera enabled device can capture sensory data, using one or more sensors 380. For example, sensors 380 can be attached to the device or to the user's body and provide real time localization measurements or inertial measurements. Localization and inertial measurements can be used by various pattern recognition algorithms, employable by the AR system 310, for example, to analyze the user behavior or preferences, and to, accordingly, present the user with targeted virtual objects or data. The device's encoder 370 can encode the video data captured by the one or more cameras 375 and embed the data captured by the one or more sensors 380 as metadata. Thus, the encoded video and the corresponding metadata can be sent to the AR system for processing, the result of which will be received at the user's display 385. As, explained before, to maintain an immersive experience, the end-to-end processing time—the time elapsed from video data capturing, through processing at the AR system 310, and delivering the virtual augmentation at the user's display—should be sufficiently short.

In an alternative, the AR system 310 receives the encoded video and corresponding metadata from the device 360 at the CVIP 240 via communication interface 255. The encoded video and corresponding metadata are first decoded, typically frame by frame, by the decoder 320. Once, the decoder 320 completes the decoding of a current frame and corresponding metadata, it can write the decoded data to the memory 230 via the data fabric 220 bus. Then, the decoder 320 can send a message to the image processor 325, via the SMN 210, informing the image processor that the decoded data of the current frame are ready. The decoder 320 can also inform the tracker 330 that the decoded data of the current frame are ready. For example, the decoder 320 can make available to the tracker 330 decoded data of a gray scale (monochrome) frame image and can make available to the image processor 325 decoded data of a color (RGB) frame image.

Upon receiving a message, via the SMN 210, that decoded data of the current frame are ready, the image processor 325 can read the decoded data from the memory 230, via the data fabric 220, and process it. For example, the image processor 325 can process coded data containing color images to evaluate the need to adjust the cameras' lens exposure, focus, or white balancing, and, accordingly, can determine camera controls. Upon completion of the processing of the decoded data, the image processor 325 can write the processed decoded data into the memory 230, via the data fabric 220, and can then send a message to the tracker 330 to inform the tracker that the processed decoded data of the current frame are ready. The image processor 325 can write the camera controls determined by the image processor directly into a mailbox of CVIP 240. The tracker 330 can then proceed to read the data processed by the image processor 325 and the CVIP 240 can immediately send the camera controls to the camera enabled device 360 via the communication interface 255.

The tracker 330 can apply algorithms that detect, recognize, and track objects at the scene based on the data captured by the cameras 375 and by the sensors 380. For example, the tracker 330 can compute a camera-model for a camera 375. Typically, a camera-model defines the camera's location and orientation (i.e., camera's pose) and other parameters of the camera, such as zoom and focus. A camera-model of a camera can be used to project the 3D scene to the camera's projection plane. A camera-model can also be used to correlate a pixel in the video image to its corresponding 3D location at the scene. Hence, the camera-model has to be continuously updated as the camera's location, orientation, or other parameters change. The tracker can also use machine learning algorithms to recognize objects at the scene, and then, e.g., based on the camera-model to compute their pose relative to the scene. For example, the tracker, can recognize an object (a table) at the scene and compute its surface location relative to a 3D representation of the scene. The tracker can then generate a 3D representation of a virtual object (a cup of tea) to be inserted at a location and an orientation relative to the table (e.g., on top of the table). At its output, the tracker can provide to the renderer 335 the virtual object representation, the location and orientation in which the virtual object is to be inserted, as well as the projection plane (the projection plane of the camera or the projection plane that is aligned with the see-through display) onto which the virtual object is to be projected—namely enhancement data. For example, the tracker can send a message to the renderer 335, to inform the renderer that enhancement data with respect to the current frame are ready in the memory to be retrieved. Upon receiving such a message, the renderer can use the enhancement data to render the virtual object onto the projection plane at the given location and orientation.

As mentioned above, since the camera moves with the movements of the user it is attached to, the tracker has to update its calculation of the camera-model (or the camera's projection plane) continuously. Moreover, if the virtual object is to be mapped onto an image plane (or a projection plane) that is consistent with the see-through display, that projection plane should be updated continuously as the user moves or changes her gaze. These updates should be at a high rate to allow for immersive content enhancement (accurate virtual object insertion). For example, by the time the renderer 335 completed the rendering of the virtual object and made it available in memory to the projector 340, it can be that small changes in the camera's pose or the see-through display's pose call for an update of the virtual object projection, rendered by the renderer 335. Thus, upon the receiving of a message from the renderer 335 that the rendered image of the virtual object is ready to be fetched from the memory 230 and a message from the tracker 330 that an update of the projection plane is also available, the projector 340 can read the rendered image and the updated projection plane, and can re-project the rendered image based on the updated projection plane. The image of the re-projected virtual object is then saved into memory 230, and a message is issued to the display driver 345 informing it that the image of the re-projected virtual object is ready in memory to be fetched and to be delivered via the communication interface 255 to the display 385 of the device. Presented on a see-through display 385, for example, the user of the device will be able to see the virtual object at the scene the user is viewing as if the object is indeed present at the scene (as if a cup of tea is indeed present on the top of the table).

In an alternative, the enhancement described above, as viewed by a user of the see-through display 385, can be viewed by another user that does not view the scene via the see-through display (i.e. third-eye feature), by means of fusing 350 the image of the current frame, provided by the image processor 325, and the image of the re-projected virtual object, provided by the projector 340. Thus, the fuser 350, prompted by a message from the image processor 325 that a processed current frame is ready in the memory 230 and a message from the projector 340 that the corresponding image of a re-projected virtual object is also ready, the fuser 350 will fetch the processed current frame and the corresponding image of the re-projected virtual object and fuse these data into one output frame that will then be saved in memory 230 to be fetched and encoded by the encoder 355, upon receiving of a message from the fuser 350. The encoded fused frame is then can be available to be stored or viewed by another user.

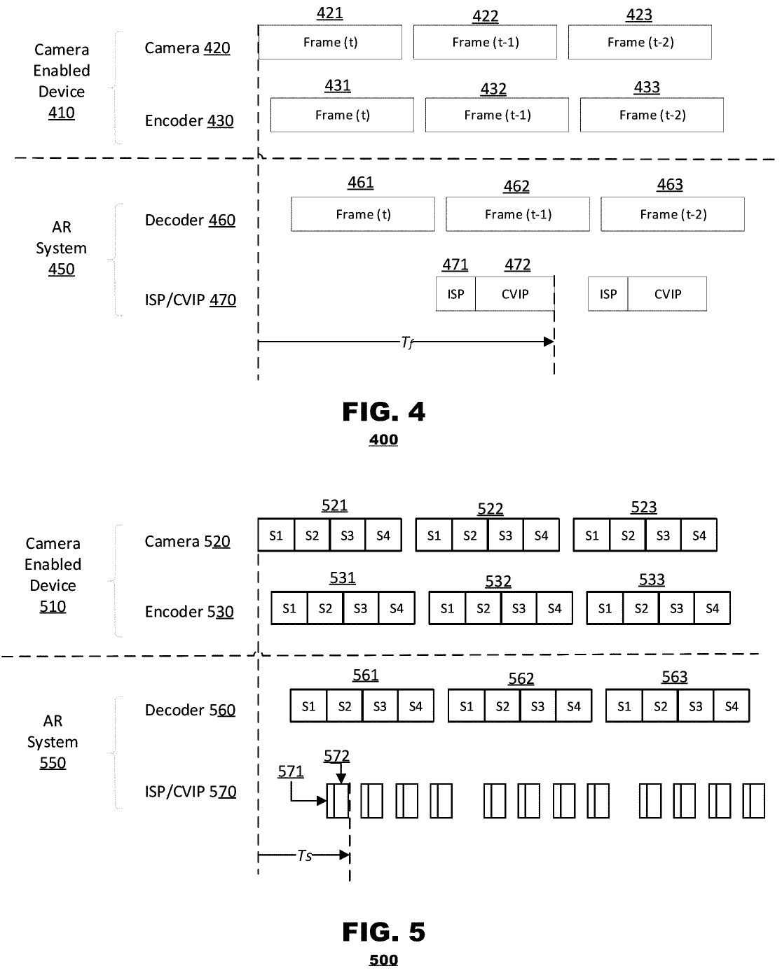

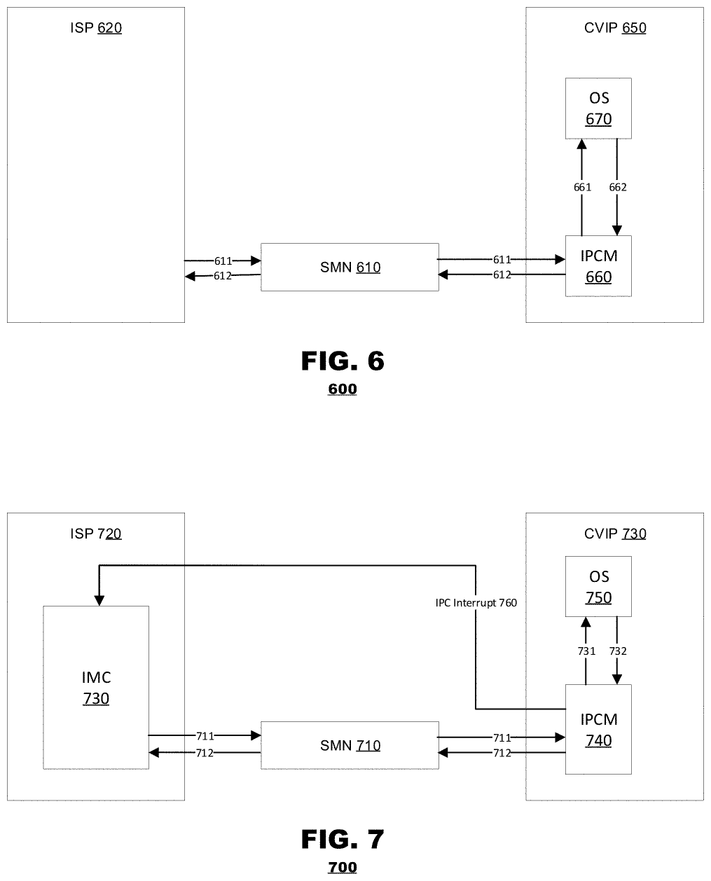

The AR system described above, in reference to FIGS. 2 and 3, is an example of a real-time system that performs pipelined operations, employing computationally heavy algorithms that involve computer vision and image processing technologies. Operating at low latency is imperative to accomplish the aim of such a system, that is, in the case of AR system, to provide sufficiently fast feedback to the user so that the user's immersive experience is preserved. The latency of a system can be assessed by measuring the time it takes data to be processed across the processing pipeline. For example, the latency of the AR system 310 when used with the camera enabled device 360 should be measured from the time a video frame is captured (one end) to the time that frame's processing is completed by the CVIP 240 (other end)—this end-to-end processing time represents the latency of the system 300. Two factors can affect the system latency. The first factor is the granularity of the data being processed through the pipeline (as described further below with reference to FIGS. 4 and 5). The second is the time spent by the system's components on messaging (as described further below with reference to FIGS. 6 and 7).

FIG. 4 is a diagram that demonstrates latency, introduced by the camera enabled device and the AR system of FIG. 3, for frame-based processing. FIG. 4 illustrates a stream of frames, f(t−2) 423, f(t−1) 422, and f(t) 421 as they enter the processing pipeline, from capturing 420 and through processing 430-470. Thus, FIG. 4 demonstrates the time delay, measured from the point in time at which a frame, e.g., 421, is captured by a camera 420, through the frame's encoding 430 (by the camera enabled device 410) and decoding 460 (by the AR system 450), to the point in time at which the frame's processing 471, 472, carried out by the ISP and CVIP components 470, has been completed. This time delay (or system latency) is denoted as T_{f} in FIG. 4. This latency can be significant when processing frames at high resolution. For example, a video that is captured at 4656 by 3496 pixel resolution requires a real-time system to be able to process 16M pixels within 33 milliseconds (msec) for a frame rate of 30 frames per second (fps) or within 16.7 msec for a frame rate of 60 fps. Assuming, a combined ISP and CVIP throughput of X pixels per second, the latency for a frame-based processing is T_{f}=33+16M/X msec for a frame rate of 30 fps and T_{f}=16.7+16M/X msec for a frame rate of 60 fps. This latency does not include the time spent on transferring data and controls, for example, via the communication interface 255 and the system's buses, 210, 220. In an alternative, the frame resolution can be reduced, by sub-sampling, from 16M pixels a frame to 4M pixels a frame. In a case where the throughput of the ISP is about 640M pixels per second, the latency of frame-based processing, measured at the output of the ISP, is 16.7+4M/640M=22.95 msec for a frame rate of 60 fps. To reduce the latency (preferably below 10 msec), in an alternative, the granularity of the system 310 processing is reduced from a frame-based processing to a slice-based processing, as is explained with reference to FIG. 5.

FIG. 5 is a diagram that demonstrates latency, introduced by the camera enabled device and the AR system of FIG. 3, for slice-based processing. In FIG. 5, the video frames 521, 522, 523, are each sliced into 4 slices, however frames with higher resolution can be sliced into a higher number of slices. FIG. 5 demonstrates the time delay, measured from the point in time at which a slice, e.g., slice S1 of frame 521, is captured by a camera 520, through the slice's encoding 530 (by the camera enabled device 510) and decoding 560 (by the AR system 550), to the point in time at which the slice's processing 571, 572, carried out by the ISP and CVIP components 570, has been completed. This time delay (or system latency) is denoted as Tₛ in FIG. 5. Depending on the number of slices a frame is partitioned into, the latency Tₛ is significantly lower than the latency T_{f} of a frame-based processing system, as described above in reference to FIG. 4. For example, assuming, as before, a combined ISP and CVIP throughput of X pixels per second, the latency for a slice-based processing with 16 slices is T_{f}=(33+16M/X)/16 msec for a frame rate of 30 fps and T_{f}=(16.7+16M/X)/16 msec for a frame rate of 60 fps. When considering the latency at the output of the ISP, in a case where the throughput of the ISP is about 640M pixels per second and the number of slices is 16, the latency of slice-based processing, measured at the output of the ISP is (16.7+4M/640M)/16=1.43 msec. This is a significant reduction when compared to the 22.95 msec of a frame-based processing.

Processing data at a slice level, as described above, reduces the system 200, 300 latency, however, more time has to be spent on communication among the system components. For example, CVIP software and ISP software and firmware are running on different processors, hence using conventional software to software communication at the slice level can mitigate the gain in latency reduction achieved by moving from a frame-based processing to a slice-based processing, as explained above. For example, communication between CVIP and ISP is bi-directional, and so can be initiated each time the CVIP informs ISP, or each time ISP informs CVIP, about the completion of a slice processing. The higher the number of slices, the higher the number of communications between CVIP and ISP. To reduce the time the system spends on communication among its components, a hybrid communication protocol is disclosed herein.

FIG. 6 is a block diagram of an example software-based communication protocol 600, in which one or more features of the disclosure can be implemented. For example, CVIP 650, upon the decoding of a slice 320 and storing the decoded slice in the memory 230, can send a message to ISP 620 to inform it that the decoded slice is ready to be fetched and processed. In response, the ISP 620 can read the decoded slice from the memory and can process it 325. Once the ISP 620 completed the processing of the slice, it can save the processed slice into memory and send a message back to the CVIP 650 to inform it that the processed slice is ready to be fetched from memory to be further processed by the CVIP 650. This communication between the ISP 620 and the CVIP 650 can be carried out through the SMN 210, 610 (e.g., a standard AXI-32 protocol-based bus). For example, when the ISP 620 has to send a message to the CVIP 650, the message can be sent 611 via the SMN 610 and can be written into a mailbox of the inter processor communication manager (IPCM) 660. An IPCM 660 can be configured to include 32 mailboxes, each containing payload registers (e.g., 7×32 bits) to store the message and a corresponding interrupt signal (e.g., 1 bit). Each message is associated with a dedicated mailbox. Once a message is written into its dedicated mailbox by the ISP, the software running on the CVIP's OS 670 is interrupted 661 by the corresponding interrupt signal. Upon an interrupt, the CVIP reads 662 the message from the mailbox, and, then acknowledges that it read the message (and therefore, the mailbox is released) by sending 612 an acknowledgment message to ISP, via the SMN 610. Hence, when using a software-based communication protocol, every transaction requires a bi-directional (round-way) handshake. That is, every transaction requires sending two messages over the SMN 610. Such a handshake consumes time that contributes to the system latency. A hybrid communication protocol is disclosed herein that does not require a round-way handshake, thereby every transaction is a one-way transaction that involves sending only one message over the SMN 610, as explained below with reference to FIG. 7.

FIG. 7 is a block diagram of an example hybrid communication protocol, in which one or more features of the disclosure can be implemented. To save the time consumed by a round-way handshake, a dedicated ISP Message Controller (IMC) 730 is designed. IMC maintains and manages hardware FIFO buffers (in-buffers and out-buffers), containing registers that hold incoming and outgoing messages. With IMC embedded hardware, when the CVIP 730 sends 712 a message to the ISP 720, via the SMN 710, the message is buffered into a register in an in-buffer of the IMC and the ISP accesses this message via a read-DMA hardware; no acknowledgment by the ISP 720 is required—i.e., no handshake message is required to release the register that stores the message as there is no concern that the message will be rewritten upon in the IMC's buffer. With IMC embedded hardware, when the ISP sends 711 a message to CVIP, via the SMN 710, the ISP first writes the message, using write-DMA hardware, into a register in an out-buffer of the IMC and then the IMC sends the message from the register, via the SMN 710, to a dedicated mailbox in the IPCM 740. Again, there is no need for a handshake (as described in reference to FIG. 6). Instead, once the CVIP reads the mailbox, it immediately toggles a hardware interrupt 760 to the IMC to inform the ISP that the mailbox 740 is released.

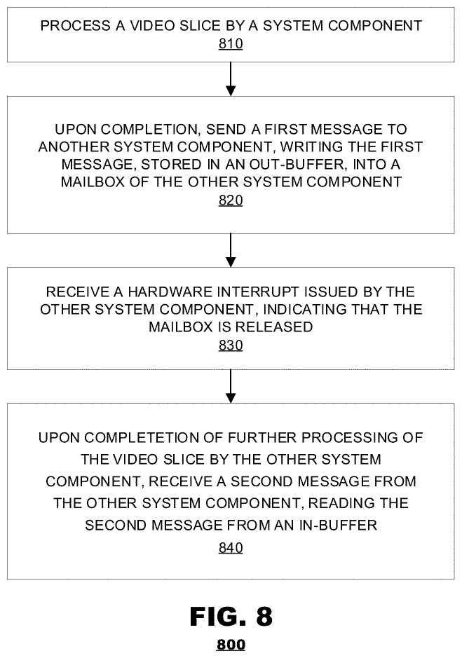

FIG. 8 is a flow chart of a method 800, with which one or more features of the disclosure can be processed. Using a hybrid communication protocol, the method 800 allows for low latency communication between system components. The method begins, in step 810, with the processing of a video slice by a system component, such as the ISP 720. When the processing of the video slice is completed, in step 820, a first message is sent to another system component, such as CVIP 730. The first message is sent as an indication that processing of the video slice is completed and that the processed slice is stored in the memory 230. To facilitate transmission, the ISP write the message in an out-buffer controlled by the IMC 730, the message is then sent to a mailbox of the CVIP via the SMN 710. In step 830, a hardware interrupt is received by the ISP, the hardware interrupt is issued by the CVIP to indicate that the mailbox has been read, and, therefore, has been released. Then, in step 840, the ISP can receive a second message from the CVIP via the SMN 710. The second message is to indicate that a further processing of the processed video slice is completed by the CVIP and that the further processed video slice is stored in the memory 230. The second messaged is written into an in-buffer controlled by the IMC 730. Hence, when using this hybrid communication protocol, the transmission of the first message and the second each constitutes one-way transaction; no acknowledgment message had to follow each of these transmissions as when using the software-based communication protocol 600.

Hence, a hybrid communication protocol is much faster than the standard software-based communication protocol, and, therefore, most suitable for transactions at the firmware and hardware layer. For example, a typical transaction between two system components, using the software-based communication protocol (described above with reference to FIG. 6), is around 350 nanoseconds with an SMN 610 clock frequency of 500 MHz. In such a case, the increase in latency that can be attributed to communication associated with a new slice of a new frame in a slice-based processing, is about 5 microseconds (given that a new slice notification requires 10 transaction). In comparison, the hybrid communication protocol, under the same conditions, consumes less than 5% of the time consumed by the software-based communication protocol.

In an alternative, a software-based communication protocol can be used at the software layer to send a less frequent messages, such as stream level communication, for example, camera property (e.g., image size or frame rate). However, communications at the hardware layer and the firmware layer that are required to be issued multiple time per a frame and per a slice, advantageously, can use the hybrid communication protocol described herein. For example, at the hardware layer, messages can be issued that indicate the readiness of input data to the ISP or output data from the ISP, including the slice buffer offset. In another example, at the firmware layer, messages can be issued with frame level information, such as frame attributes, frame buffer allocation, or frame id.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of communication between system components, using a hybrid communication protocol, comprising:
processing a slice of a video by a first system component;
sending a first message to a second system component indicating that the processed slice is stored in a memory, wherein the sending of the first message comprises writing the first message, stored in an out-buffer of the first system component, into a mailbox of the second system component; and
receiving a hardware interrupt issued by the second system component indicating that the mailbox is released.

2. The method of claim 1, wherein the out-buffer is managed by a hardware message controller that controls the writing, by the first system component, of messages to the out-buffer via a direct memory access.

3. The method of claim 1, further comprising:
receiving a second message from the second system component indicating that a further processing of the processed slice is completed and that the further processed slice is stored in the memory, wherein the receiving of the second message is a one-way transaction that comprises reading the message from an in-buffer of the first system component and wherein the reading completes the transaction.

4. The method of claim 3, wherein the in-buffer is managed by the hardware message controller that controls the reading, by the first system component, of messages from the in-buffer via a direct memory access.

5. The method of claim 1, wherein the first system component and the second system component are components of an augmented reality system, and wherein the video is received from a camera enabled device.

6. The method of claim 5, wherein:
the first system component performs operations that comprise determining camera controls for a camera of the camera enabled device, and
the second system component performs operations that comprise computing a projection plane.

7. A method of communication between components of a system, using a hybrid communication protocol, comprising:
processing a slice of a video by a first system component;
sending a first message to a second system component indicating that the processed slice is stored in a memory, wherein:
the sending of the first message is a one-way transaction that comprises writing the first message into an in-buffer of the second system component and wherein the writing completes the transaction.

8. The method of claim 7, further comprising:
receiving a second message from the second system component indicating that a further processing of the processed slice is completed and that the further processed slice is stored in the memory, wherein:
the receiving of the second message comprises reading the second message from a mailbox of the first system component and issuing a hardware interrupt to the second system component indicating that the mailbox is released.

9. The method of claim 7, wherein the first system component and the second system component are components of an augmented reality system, and wherein the video is received from a camera enabled device.

10. The method of claim 9, wherein:
the first system component performs operations that comprise computing a projection plane, and
the second system component performs operations that comprise determining camera controls for a camera of the camera enabled device.

11. A first system component, comprising:
at least one processor; and
memory storing instructions that, when executed by the at least one processor, cause the first system component to:
process a slice of a video;
send a first message to a second system component indicating that the processed slice is stored in a memory, wherein the sending of the first message comprises writing the first message, stored in an out-buffer of the first system component, into a mailbox of the second system component; and
receive a hardware interrupt issued by the second system component indicating that the mailbox is released.

12. The first system component of claim 11, wherein the out-buffer is managed by a hardware message controller that controls the writing, by the first system component, of messages to the out-buffer via a direct memory access.

13. The first system component of claim 11, wherein the memory storing instructions further cause the first system component to:
receive a second message from the second system component indicating that a further processing of the processed slice is completed and that the further processed slice is stored in the memory, wherein the receiving of the second message is a one-way transaction that comprises reading the message from an in-buffer of the first system component and wherein the reading completes the transaction.

14. The first system component of claim 13, wherein the in-buffer is managed by the hardware message controller that controls the reading, by the first system component, of messages from the in-buffer via a direct memory access.

15. A first system component, comprising:
at least one processor; and
memory storing instructions that, when executed by the at least one processor, cause the first system component to:
process a slice of a video;
send a first message to a second system component indicating that the processed slice is stored in a memory, wherein:
the sending of the first message is a one-way transaction that comprises writing the first message into an in-buffer of the second system component and wherein the writing completes the transaction.

16. The first system component of claim 15, wherein the memory storing instructions further cause the first system component to:
receive a second message from the second system component indicating that a further processing of the processed slice is completed and that the further processed slice is stored in the memory, wherein:
the receiving of the second message comprises reading the second message from a mailbox of the first system component and issuing a hardware interrupt to the second system component indicating that the mailbox is released.

17. A non-transitory computer-readable medium comprising instructions executable by at least one processor to perform a method, the method comprising:
processing a slice of a video by a first system component;
sending a first message to a second system component indicating that the processed slice is stored in a memory, wherein the sending of the first message comprises writing the first message, stored in an out-buffer of the first system component, into a mailbox of the second system component; and
receiving a hardware interrupt issued by the second system component indicating that the mailbox is released.

18. The medium of claim 17, further comprising:
receiving a second message from the second system component indicating that a further processing of the processed slice is completed and that the further processed slice is stored in the memory, wherein the receiving of the second message is a one-way transaction that comprises reading the message from an in-buffer of the first system component and wherein the reading completes the transaction.

19. A non-transitory computer-readable medium comprising instructions executable by at least one processor to perform a method, the method comprising:
processing a slice of a video by a first system component;
sending a first message to a second system component, indicating that the processed slice is stored in a memory, wherein:
the sending of the first message is a one-way transaction that comprises writing the first message into an in-buffer of the second system component and wherein the writing completes the transaction.

20. The medium of claim 19, further comprising:
receiving a second message from the second system component indicating that a further processing of the processed slice is completed and that the further processed slice is stored in the memory, wherein:
the receiving of the second message comprises reading the second message from a mailbox of the first system component and issuing a hardware interrupt to the second system component indicating that the mailbox is released.
